(19) United States
(12) Patent Application Publication
(10) Pub. No.: US 2007/0226743 A1
(43) Pub. Date: Sep. 27, 2007

(54) Parallel-distributed-processing program and parallel-distributed-processing system

(75) Inventor: Ken Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/488,229

(22) Filed: Jul. 18, 2006

(30) Foreign Application Priority Data
Mar. 27, 2006 (JP) 2006-086126

(51) Int. Cl. G06F 9/46

(52) U.S. Cl. 718/104

(57) ABSTRACT

In a parallel-distributed-processing program/system, data volume of a processing object of a given job is measured, resource demand required for processing is estimated on the basis of the measured data volume, the resources corresponding to the estimated demand are reserved in a resource pool, the assignment of a job to the respective reserved resources is optimized in response to the throughput of the resources so as to almost equalize the processing time in the resources, the job is divided into a plurality of child jobs according to the optimized assignment, the divided child jobs are inputted into the resources, respectively, the child jobs that are distributed and processed by the resources are combined, the reserved resources are released.

### BACKGROUND OF THE INVENTION

The present invention relates to a parallel-distributed-processing program that makes a computer divide a job and execute a parallel distribution processing by a plurality of resources. The present invention also relates to a parallel-distributed-processing system that uses the program.

A parallel processing method has been developed to process a job efficiently. In the method, a job is divided into a plurality of parts and a plurality of resources process the parts, respectively. For example, JP7-219787A discloses system sharing method. According to the disclosed method, when a system is shared by a plurality of groups, an efficient resource allocation is predicted on the basis of the information about jobs of the respective groups and the optimal job execution environment is established. Then, the system processes the jobs with the established environment.

However, the method of JP7-219787A cannot reduce variation in the execution environment among groups when resources that can be assigned to the respective groups have variation even if the optimal execution environment is established to the resource assigned to each group. Therefore, since the processing time varies greatly with groups, a group with a slow processing speed forms a bottleneck and delays the entire process of the job.

### SUMMARY OF THE INVENTION

It is therefore an object of the present invention to provide an improved parallel-distributed-processing program, which is capable of assigning divided parts of a job to available resources optimally.

For the above object, according to the present invention, there is provided a parallel-distributed-processing program that makes a computer execute steps including a step for measuring data volume of a processing object of a given job, a step for estimating resource demand required for processing on the basis of the measured data volume, a step for reserving the resources corresponding to the estimated demand in a resource pool, a step for optimizing the assignment of a job to the respective reserved resources in response to the throughput of the resources so as to almost equalize the processing time in the resources, a step for dividing the job into a plurality of child jobs according to the optimized assignment, a step for inputting the divided child jobs into the resources, respectively, a step for combining the child jobs that are distributed and processed by the resources, and a step for releasing the reserved resources.

It is preferable to repeat the step for reserving resources without proceeding to the next step until the time when resources corresponding to the demand are reserved.

A parallel-distributed-processing system according to the present invention, where a given job is divided into a plurality of child jobs to be distributed over a plurality of resources and the child jobs are processed by the resources in parallel, includes means for measuring data volume of processing object of the given job, means for estimating resource demand required for processing on the basis of the measured data volume, means for reserving the resources corresponding to the estimated demand in a resource pool, means for optimizing the assignment of a job to the respective reserved resources in response to the throughput of the resources so as to almost equalize the processing time in the resources, means for dividing the job into a plurality of child jobs according to the optimized assignment, means for inputting the divided child jobs into the resources, respectively, means for combining the child jobs that are distributed and processed by the resources, and means for releasing the reserved resources.

It is preferable to repeat the process by the resource reserving means without executing the next means until the time when resources corresponding to the demand are reserved.

Further, the parallel-distributed-processing system of the present invention can be applied to environment where a computer of a job request side is connected to computers that constitute the resources included in the resource pool via a network.

According to the parallel-distributed-processing program/system of the present invention, since the resources corresponding to resource demand are reserved and the divided jobs are assigned in response to the throughput of the respective resources, the processing time that is required to process the assigned job by the resource is almost constant even if the throughput of the resources have large differences. This can shorten the processing time for the job as a whole. In particular, the present invention has significant effect to save the processing time of a job net (an interest calculation or the like) in which jobs that require a large amount of data processing are connected in series.

Further, since the division and processing of a job are executed after the reservation of the resources corresponding to the resource demand is completed, an expected completion time can be accurately grasped before a job is executed.

### DESCRIPTION OF THE ACCOMPANYING DRAWINGS

FIG. 1 is a block diagram showing a parallel-distributed-processing system of an embodiment according to the present invention,

FIG. 2 is a flowchart showing contents of the parallel-distributed-processing program of the embodiment according to the present invention from the start to the end, and

FIG. 3 is a chart showing the contents of the parallel-distributed-processing program of the embodiment according to the present invention as means of functions of the program together with processing of jobs in the resources.

### DESCRIPTION OF THE PREFERRED EMBODIMENTS

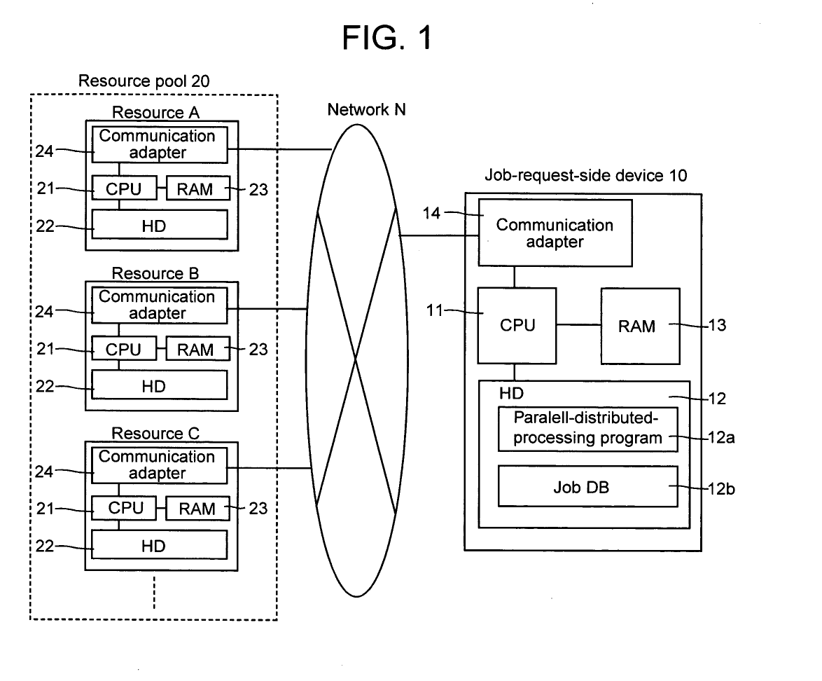

Hereafter, the embodiment of the parallel-distributed-processing program and the parallel-distributed-processing system of the present invention will be described with reference to the drawings. First, the outline of a network system to which the parallel distributed processing system of the embodiment is applied is described with reference to FIG. 1. As shown in a FIG. 1, the distributed processing system consists of a job-request-side device (computer) 10 and a plurality of resources (computers) A, B, C, . . . that are connected to each other via a network N such as the Internet. These resources constitute a resource pool 20.

The job-request-side device 10 is provided with a CPU 11 and a hard disk (HD) 12, a memory (RAM) 13, a communication adapter 14 that are connected to the CPU11. A parallel-distributed-processing program 12a for dividing a job into child jobs to be processed by the resources and system programs such as an operating system (not shown) are installed in the HD 12. Further, a job DB(database) 12b for managing a job is constructed in the HD 12. The job-request-side device 10 divides a given job into a plurality of child jobs and distributes them over a plurality of resources in the resource pool 20 so that the child jobs are processed in parallel.

Each of the resources A, B, C, . . . is provided with a CPU 21 and a HD 22, a RAM 12, a communication adapter 24 that are connected to the CPU 21. Each of the resources A, B, C, . . . has a function to process the child job distributed by the job-request-side device 10 and a function to return the processed child job to the job-request-side device 10.

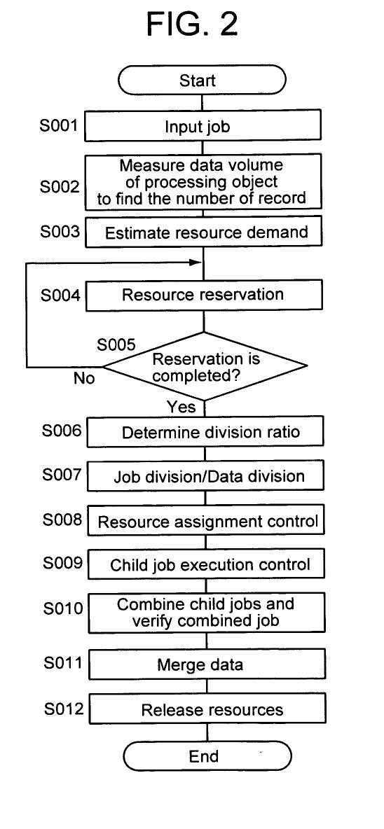

Next, the process contents of the parallel-distributed-processing program 12a will be described with reference to the flow chart shown in FIG. 2. Starting the parallel distributed process, the job-request-side device 10 declares an input of the job into a job execution queue and gives identification information (job ID) of the inputted job (S001). The job ID includes a field for storing the identifier to distinguish from other jobs, a field for storing the number n of records contained in this job, a field for storing a unit operation amount u that is an operation amount required to process one record, and a field for storing identifiers of child jobs (child job ID) that are inputted after dividing the inputted job into the child jobs. In the field of the number of records, Null is stored at the time of a job input. Before the job is divided, Null is stored in the field of child job ID to show that the job is not yet divided. Values corresponding to the job are set to the fields of the identifier and the unit operation amount.

Subsequently, the job-request-side device 10 measures the data volume of a processing-object of the job to find the number n of records (S002). In the case of a fixed-length record, the number n of records is calculated by using
n=D/L
where D is data volume [byte] of the processing-object of the job and L is record length [byte] The calculated number of records is stored into the field of the number of records.

Next, the job-request-side device 10 estimates resource demand required for processing on the basis of the number n of records calculated in S002 and the unit operation amounts u (S003). Operation amount c required in order to complete processing is calculated by c=u×n. The resource demand is calculated by multiplying the operation amount c by a system coefficient s. The value of the system coefficients is adjustable for each of systems in order to quantify the operation amount. Hypothetical unit RS is used for the resource demand d that is calculated by multiplying the operation amount c by system coefficient for convenience. For example, assuming that the record number n=2,500 sets, the unit operation amount u=20 steps and the system coefficient s=0.0001 in a processing object of a certain job, the operation amount c and the resource demand d are calculated as follows.
c=n×u=50,000 [step]
d=c×s=5 [RS]

Subsequently, the job-request-side device 10 reserves the resources corresponding to the estimated resource demand in the resource pool 20 (S004). A resource capacity coefficient x is defined for each of the resource A, B and C included in the resource pool 20. The resource capacity coefficient x evaluates the throughput of each resource, and its unit is RS as well as the unit of the above-mentioned resource demand. The higher the throughput is, the larger the resource capacity coefficient x is. The job-request-side device 10 reserves resources so that the total amount of the resource capacity coefficients is coincident with the resource demand. For example, it is assumed that the resources A, B, C and D in the resource pool 20 can be reserved and the resource capacity coefficients of the resources A, B, C and D are “2”, “1”, “3” and “4”, respectively. In this situation, if the resource demand d is 5 [RS], the job-request-side device 10 reserves the resources A and C or reserves the resources B and D. At the time of reservation of the resources, the device 10 preferentially chooses a combination of resources whose total amount of the resource capacity coefficients is equal to a resource demand. However, when such a combination does not exist, the device 10 chooses the minimum combination among combinations whose total amount of the resource capacity coefficients is larger than the resource demand. For example, when the resource demand is •6.5•, the device 10 chooses the combination of the resources C and D or the combination of the resources A, B and D.

Subsequently, the job-request-side device 10 judges whether the resource reservation in S004 has been completed or not (S005). If the resource reservation is not completed, the device executes the process in S004 again. In this manner, the device 10 repeats the resource reservation until the time when the resources corresponding to the resource demand are reserved. After reserving the resources, the device 10 proceeds the process to the next step.

If a reservation is completed (S005, Yes), the job-request-side device 10 optimizes assignment of the job to the respective reserved resources in response to the throughput of the resources so as to almost equalize the processing time in the resources (determines division ratio, S006). For example, when the resources A and C are reserved for the resource demand “5”, the number of partitions (the number of child jobs) becomes “2” and the division ratio (resources A:C) is determined as 2:3. If the number of records of the processing-object is equal to 2,500 sets (n=2,500) as mentioned above, 1000 sets are assigned to the resource A and 1500 sets are assigned to the resource C.

Subsequently, the job-request-side device 10 divides the job and the data (S007) on the basis of the number of partitions and the division ratio that are determined in S006, assigns the child jobs and data divided in S006 to the respective resources reserved in S004 (S008). The respective resources to which the child jobs are assigned execute the assigned child jobs in parallel (distributed processing in each resource, S009).

Since a job is assigned to each resource corresponding to the throughput (the resource capacity coefficient) so that the processing time may become almost equal, the processes for the child jobs in the respective resources finish almost simultaneous, which can avoid the delay of the entire process due to a bottleneck resource.

After finishing the process, the respective resources return the processing results to the job-request-side device 10. The job-request-side device 10 combines the returned child jobs that are distributed and processed by the respective resources, and verifies the combined job (S010). Subsequently, the device 10 merges the result data of the returned child jobs that are distributed and processed by the respective resources (S011), and releases the reserved resources (S012).

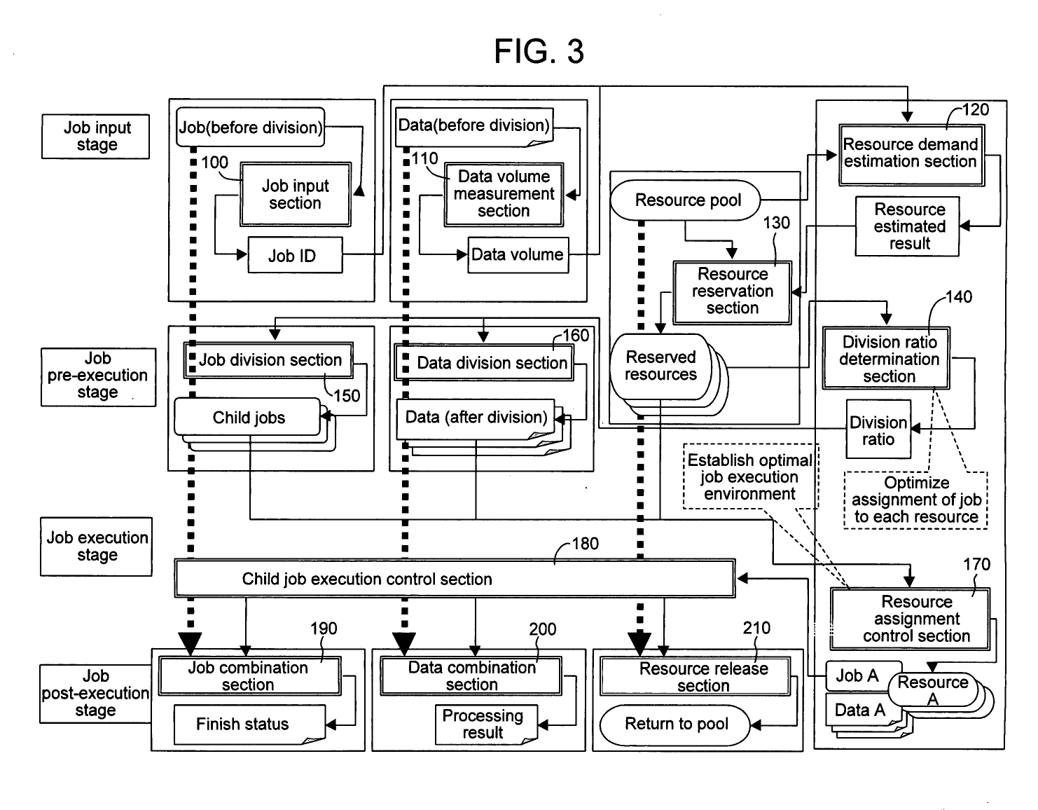

FIG. 3 is a chart showing the contents of the parallel-distributed-processing program shown in the flowchart in FIG. 2 as means of functions of the program together with processing of jobs in the resources. In the chart in FIG. 3, the entire process is divided into four stages that are a job input stage, a job pre-execution stage, a job execution stage, and a job post-execution stage. The process in each stage will be described in order.

In the job input stage, the job before division is inputted into a job input section 100, and the data before division is inputted into a data-volume-measurement section 110. A job ID included in a job and data volume calculated by the data-volume-measurement section 110 are inputted into a resource-demand-estimation section 120 that calculates resource demand. The calculated resource estimated result is sent to a resource reservation section 130. The resource reservation section 130 chooses resources corresponding to the resource demand from the resource pool and reserves the chosen resources.

In the job pre-execution stage, a division ratio determination section 140 determines the division ratio of the job on the basis of the resource capacity coefficients of the reserved resources. A job division section 150 and a data division section 160 divide the job and data, respectively, based on the determined division ratio. In the job execution stage, a resource-assignment-control section 170 transmits the divided jobs (child jobs) and data to the respective reserved resources. A child-job-execution-control section 180 controls execution of the child job in each resource.

In the job post-execution stage, a job combination section 190 combines the child jobs, a data combination section 200 merges the data, and a resource release section 210 releases the reserved resources to return them to the resource pool. When the process finishes normally, the job combination section 190 outputs a finish status and the data combination section 200 outputs the data as the processing result.

As described above, according to the parallel-distributed-processing program and system of the embodiment, since the resource demand is estimated on the basis of the data volume and the job is divided after reserving resources corresponding to the resource demand, the job can be divided and assigned to the available resources optimally, which can reduce the processing time of the entire system.

The parallel-distributed-processing program and system of the present invention are applicable to a routine work (a batch process) such as a deposit data processing of a bank and a sales data tabulation processing of a store, for example.

What is claimed is:

1. A parallel-distributed-processing program that makes a computer execute steps comprising:
a step for measuring data volume of a processing object of a given job,
a step for estimating resource demand required for processing on the basis of the measured data volume,
a step for reserving the resources corresponding to the estimated demand in a resource pool,
a step for optimizing the assignment of said job to the respective reserved resources in response to the throughput of the resources so as to almost equalize the processing time in the resources,
a step for dividing said job into a plurality of child jobs according to the optimized assignment,
a step for inputting said child jobs into the resources, respectively,
a step for combining said child jobs that are distributed and processed by the resources, and
a step for releasing the reserved resources.

2. The parallel-distributed-processing program according to claim 1, wherein said step for reserving resources is repeatedly executed without proceeding to the next step until the time when resources corresponding to the estimated demand are reserved.

3. A parallel-distributed-processing system that divides a given job into a plurality of child jobs to be distributed over a plurality of resources and said child jobs are processed by the resources in parallel, said system comprising:
means for measuring data volume of processing object of a given job,
means for estimating resource demand required for processing on the basis of the measured data volume,
means for reserving the resources corresponding to the estimated demand in a resource pool,
means for optimizing the assignment of said job to the respective reserved resources in response to the throughput of the resources so as to almost equalize the processing time in the resources,
means for dividing said job into a plurality of child jobs according to the optimized assignment,
means for inputting said child jobs into the resources, respectively,
means for combining said child jobs that are distributed and processed by the resources, and
means for releasing the reserved resources.

4. The parallel-distributed-processing system according to claim 3, wherein said means for reserving resources is repeatedly executed without executing the next means until the time when resources corresponding to the estimated demand are reserved.

5. The parallel-distributed-processing system according to claim 3, wherein a computer of a job request side is connected to computers that constitute said resources included in said resource pool via a network.
